(19) United States
(12) Patent Application Publication
(10) Pub. No.: US 2025/0080674 A1
(43) Pub. Date: Mar. 6, 2025

(54) IMAGE FORMING APPARATUS AND IMAGE FORMING METHOD

(71) Applicant: SHARP KABUSHIKI KAISHA, Sakai City (JP)

(72) Inventor: MASAHIRO MORISHITA, Sakai City (JP)

(21) Appl. No.: 18/807,053

(22) Filed: Aug. 16, 2024

(30) Foreign Application Priority Data
Sep. 1, 2023 (JP) 2023-142579

(51) Int. Cl. H04N 1/32; H04N 1/00

(52) U.S. Cl. CPC H04N 1/32133; H04N 1/00843; H04N 1/00875; H04N 1/00384; H04N 1/00411; H04N 1/00421; H04N 2201/0094; H04N 2201/3205; H04N 2201/3214; H04N 2201/3215; H04N 2201/3235

(57) ABSTRACT

An image forming apparatus includes one or more controllers that control giving of additional information to image information, and an image former that forms an image of a code related to the additional information to be given to an image of the image information in a case where the additional information is given under control of the one or more controllers. The one or more controllers give, to the image information, the additional information that differs in response to a type of the image information.

### TECHNICAL FIELD

The disclosure relates to an image forming apparatus and the like.

### BACKGROUND ART

There is known a printing device capable of individually managing a medium on which an electronic document is printed and tracking later various kinds of information relating to the electronic document as well as various kinds of information obtained at the time of printing the electronic document.

### SUMMARY

### Technical Problem

An object of the disclosure is to provide an image forming apparatus and the like capable of flexible output management of image information as printed matter by performing control of giving additional information to the image information.

### Solution to Problem

In order to solve the above-mentioned issue, an image forming apparatus according to the disclosure includes one or more controllers that control giving of additional information to image information, and an image former that forms an image of a code related to the additional information to be given to an image of the image information in a case where the additional information is given under control of the one or more controllers, wherein the one or more controllers give, to the image information, the additional information that differs in response to a type of the image information.

An image forming method according to the disclosure includes controlling of giving additional information to image information, and forming an image of a code related to the additional information to be given to an image of the image information in a case where the additional information is given, wherein the additional information that differs in response to a type of the image information is given to the image information.

### Advantageous Effects of Disclosure

According to the disclosure, it is possible to provide an image forming apparatus and the like capable of flexible output management of image information as a printed matter by controlling of giving additional information to the image information.

### BRIEF DESCRIPTION OF DRAWINGS

FIG. 1 is a diagram for explaining a connection mode of an image forming apparatus and an information processing device according to a first embodiment.

FIG. 2 is a diagram for explaining a functional configuration of the image forming apparatus according to the first embodiment.

FIG. 3 is a diagram for explaining additional information according to the first embodiment.

FIG. 4 is a diagram for explaining a functional configuration of the information processing device according to the first embodiment.

FIG. 5 is a flowchart for explaining a procedure according to the first embodiment.

FIG. 6 is a diagram for explaining an operation example according to the first embodiment.

FIG. 7 is a diagram for explaining an operation example according to the first embodiment.

FIG. 8 is a diagram for explaining an operation example according to the first embodiment.

FIG. 9 is a diagram for explaining an operation example according to the first embodiment.

FIG. 10 is a diagram for explaining an operation example according to the first embodiment.

FIG. 11A and FIG. 11B are diagrams for explaining an operation example according to the first embodiment.

FIG. 12 is a flowchart for explaining a procedure according to a second embodiment.

FIG. 13 is a flowchart for explaining a procedure according to a third embodiment.

FIG. 14 is a diagram for explaining an operation example according to the third embodiment.

### DESCRIPTION OF EMBODIMENTS

Embodiments according to the disclosure will be described below with reference to the drawings. Note that the following embodiments are examples for explaining the disclosure, and the technical content of the explanation described in the claims is not limited to the following description.

There is known an image forming apparatus that outputs a code obtained by encoding various kinds of information with one or more of, for example, a two-dimensional code (quick response code: QR code (trade name)), a one-dimensional code (bar code), a sign, and an alphanumeric character as a printed matter together with a print image.

For example, there is known a printing device that generates a code image as a code for printing from code information for uniquely identifying a medium on which an electronic document is printed, and prints the generated code image and a document image on the medium.

The printing device is a device that enables individual management of a medium on which an electronic document is printed using a code image printed together with a document image, and tracks later various kinds of information regarding the electronic document as well as various kinds of information obtained when the electronic document is printed.

However, in the related art, it is not possible to perform output management of a printed matter satisfying a security level required by a user, such as changing contents of various kinds of information represented by a code in accordance with an electronic document (document image) or giving a code only under a specific condition.

In the disclosure, an image forming apparatus or the like capable of flexible output management of image information as a printed matter is achieved by controlling of giving additional information to the image information in the following embodiments.

### 1. First Embodiment

### 1.1 Overall Configuration

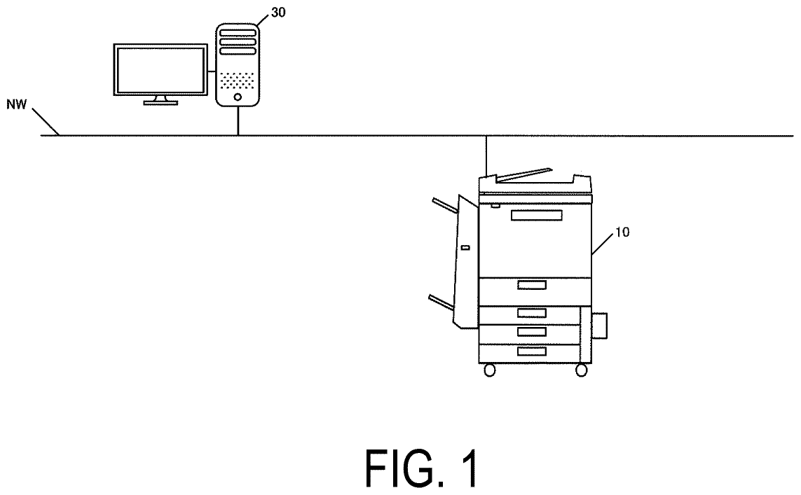

FIG. 1 is a diagram for explaining an example of a connection mode of a multifunction peripheral 10 as an image forming apparatus and a terminal device 30 as an information processing device according to a first embodiment.

The multifunction peripheral 10 is an example of an image forming apparatus that can execute various kinds of jobs such as print, copy, fax, and image transmission in one housing. Note that the image forming apparatus according to the disclosure is not limited to the multifunction peripheral 10, and may be an image forming apparatus specialized in a specific function such as a printer or a facsimile. As long as the multifunction peripheral 10 is so configured as to execute a job based on the job received from the terminal device 30, the type, configuration, performance, and the like of the multifunction peripheral 10 are not limited. The multifunction peripheral 10 is connected to a network NW in such a manner as to be able to communicate with the terminal device 30 and other devices (not illustrated). The multifunction peripheral 10 may be connected to another network NW (not illustrated) connected to the network NW, or a plurality of the multifunction peripherals 10 may be connected to the network NW.

The terminal device 30 can be configured as a computer that operates under control of a specific operating system (OS). The terminal device 30 is not limited in device type, device configuration, device performance, and the like as long as it is so configured as to generate a job based on a print setting or a facsimile setting received via a job execution screen to be described later and transmit the job to the multifunction peripheral 10. The terminal device 30 may be connected to another network NW (not illustrated) connected to the network NW, or a plurality of the terminal devices 30 may be connected to the network NW.

### 1.2 Functional Configuration

### 1.2.1 Multifunction Peripheral 10

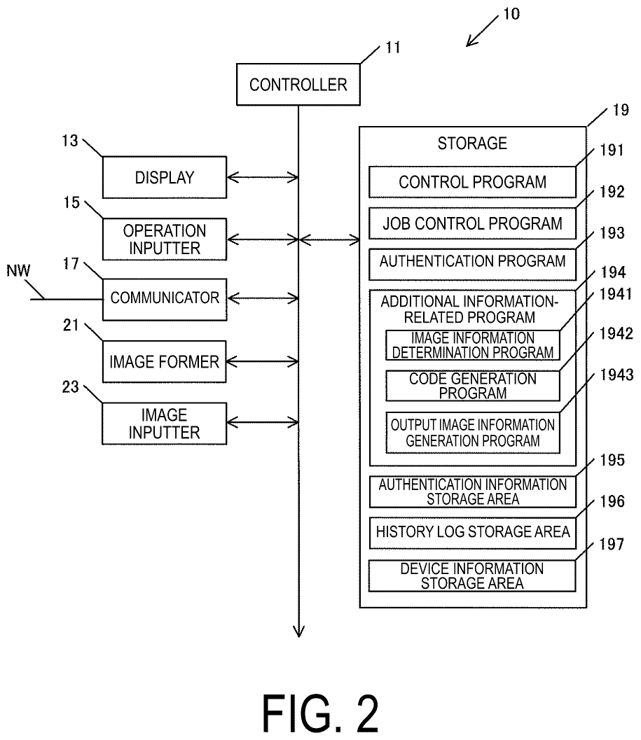

A functional configuration of the multifunction peripheral 10 will be described with reference to FIG. 2. FIG. 2 is a diagram for explaining the functional configuration of the multifunction peripheral 10. The multifunction peripheral 10 includes a controller 11, a display 13, an operation inputter 15, a communicator 17, a storage 19, an image former 21, and an image inputter 23.

The controller 11 controls the entire multifunction peripheral 10. The controller 11 is configured of, for example, one or multiple arithmetic devices (central processing unit (CPU), system on a chip (SoC), or the like). The controller 11 implements a function thereof by reading and executing various programs stored in the storage 19.

The display 13 is a display device that displays various types of information for a user or the like. The display 13 can be configured of, for example, a liquid crystal display (LCD) or an organic electro-luminescence (EL) display.

The operation inputter 15 is an input device that receives input of information by the user or the like. The operation inputter 15 can be configured of, for example, various input devices such as operation keys (for example, hardware keys and software keys) and buttons. The operation inputter 15 can be configured as a touch panel that enables input via the display 13. In this case, as an input method for the touch panel, for example, a general method such as a resistance film method, an infrared beam method, an electromagnetic induction method, or an electrostatic capacitance method can be employed.

The communicator 17 includes, for example, one or both of wired and wireless interfaces for communication with another device (terminal device 30) via the network NW such as a local area network (LAN), a wide area network (WAN), the Internet, a telephone line, or a fax line. In addition, the communicator 17 may include an interface related to a (short-range) wireless communication technology such as Bluetooth (trade name), near field communication (NFC), Wi-Fi (trade name), ZigBee (trade name), Infrared Data Association (IrDA), or a wireless USB.

The image former 21 feeds a sheet from a feed tray (not illustrated), forms an image of a code related to additional information to be given along with an image of image information, and then discharges the sheet to a paper discharger (not illustrated). The image former 21 may be configured of, for example, a laser printer using an electrophotographic system. In this case, the image former 21 performs image formation using toners supplied from toner cartridges (not illustrated) corresponding to toner colors (for example, cyan, magenta, yellow, and black).

The image inputter 23 generates image information by scanning a document. The image inputter 23 can be configured as a scanner device that is provided with an image sensor such as a charge coupled device (CCD) or a contact image sensor (CIS) and that includes an automatic document feeder (ADF), a flatbed on which a document is set to be read, and the like. The configuration of the image inputter 23 is not particularly limited as long as the image inputter 23 can generate image data by reading a reflected light image from an original image using the image sensor. The image inputter 23 also can be configured as an interface that can acquire, for example, document data stored in an external storage medium such as a universal serial bus (USB) memory and a print job transmitted from the terminal device 30.

The storage 19 is constituted of one or more storage devices and stores various programs and various types of data necessary for the operation of the multifunction peripheral 10. The storage 19 may be constituted by, for example, a storage device such as a random access memory (RAM), a hard disk drive (HDD), a solid state drive (SSD), or a read only memory (ROM).

In the first embodiment, the storage 19 stores a control program 191, a job control program 192, an authentication program 193 and an additional information-related program 194, and secures an authentication information storage area 195, a history log storage area 196, and an apparatus information storage area 197.

The control program 191 is a program read by the controller 11 when the controller 11 performs centralized control of the multifunction peripheral 10. The controller 11, after reading out the control program 191, controls driving of hardware such as the display 13, the operation inputter 15, the communicator 17, the image former 21, and the image inputter 23.

The job control program 192 is a program to be read out by the controller 11 when executing a job such as print (including print hold), copy, fax, or image transmission. When the controller 11 has read out the job control program 192, it shifts to a job mode (a print (copy) mode, a fax mode, an image transmission mode, or the like) for executing each job, and then executes the corresponding job. When a job is to be executed, the controller 11 displays the job execution screen on the touch panel configured as the operation inputter 15 (display 13). The job execution screen receives a setting value, a function selection, or the like necessary for executing the job from the user as needed. The controller 11 executes each job based on a setting value, a function, or the like received via the job execution screen.

Note that in the disclosure, when a print job and a copy job are not distinguished from each other, they are collectively referred to as a print job, and image formation (operation) based on the print job is referred to as printing.

The print hold is one of print functions in which image information acquired as a print job at the time of printing is temporarily held in the storage 19 and printing is performed based on an operation command from a user. In this case, a preview image generated based on the held image information (including a code related to additional information described later when the additional information is given) is displayed on the touch panel, thereby making it possible to check a print image before printing.

The authentication program 193 is a program that is read out by the controller 11 when a user who attempts to log into the multifunction peripheral 10 is authenticated. After reading out the authentication program 193, the controller 11 functions as an authenticator that operates based on a user authentication function, and causes a login screen (not illustrated) to be displayed on the touch panel and then receives input of authentication information related to the user authentication when the user authentication function is enabled. For example, in a case where the authentication condition is a combination of a login user name and a login password, the controller 11 can perform user authentication by storing login user names and login passwords related to the user authentication in association with each other in advance and checking the login user name and the login password input via the login screen against the stored login user names and login passwords. The user authentication may be, for example, possession-based authentication using a token, a key, an integrated circuit (IC) card or a smartphone, or biometric authentication such as face authentication or fingerprint authentication, in addition to knowledge-based authentication combining a login user name and a login password. Note that the controller 11 can receive setting of enabling/disabling the user authentication function via a system setting screen described later or the like.

The additional information-related program 194 is a program that is read out by the controller 11 when a job to be executed is received and the job is a print job. After the controller 11 has read out the additional information-related program 194, when a command for giving additional information to the image information related to the print job is included, the controller 11 executes processing associated with the giving of the additional information. Here, the additional information according to the disclosure is information that is given to the image information related to the print job, includes specific information or job specific information described below, and is converted into encoded image by encoding.

The additional information-related program 194 includes an image information determination program 1941, a code generation program 1942, and an output image information generation program 1943. The controller 11, after reading out the image information determination program 1941, determines whether the type of the image information related to the print is image information of a document that certifies authenticity of contents when the job to be executed is a print job. Here, the document that certifies the authenticity of the contents is a kind of document utilized inside or outside an organization to which the user who executes the print job belongs, and refers to an official document (hereinafter, referred to as an official document in the disclosure) which has been approved by a plurality of administrators as necessary with respect to the document created by the user. On the other hand, in a case where it is determined that the type of the image information related to the print is not a document that certifies the authenticity of the contents, the controller 11 determines the above image information as another document (hereinafter referred to as a non-official document (general job) in the disclosure) different from the document that certifies the authenticity of the contents. The controller 11, after reading out the image information determination program 1941, can determine the type of the image information related to the received print job by referencing an identifier representing the type of the image information (for example, numerical values or characters such as “1” or “Yes” in the case of an official document and “0” or “No” in the case of a non-official document), the content of the additional information related to the command for giving the additional information, or the like.

The code generation program 1942 is a program that is read out by the controller 11 when generating a code related to additional information. When the type of the image information related to the print is image information related to an official document, the controller 11, after reading out the code generation program 1942, takes specific information including organization information regarding an organization to which the user who executes the print job belongs as additional information, and generates image information (encoded information) of a code related to the additional information. On the other hand, when the type of the image information related to the print is image information related to a non-official document, the controller 11 takes job specific information including job information relating to the print job and apparatus information of the multifunction peripheral 10 as additional information, and generates encoded information of a code related to the additional information. The encoded information may be a one-dimensional code such as a barcode (for example, EAN code, JAN code, Codbar, CODE128, or the like) or may be a two-dimensional code. The two-dimensional code may be a stack type two-dimensional code (for example, PDF417, CODE49, or the like) or a matrix type two-dimensional code (for example, a quick response code (QR code (trade name)), DataMatrix, VeriCode, or Aztec). In the following description, a quick response code (QR code (trade name)) will be described as an example of encoded information.

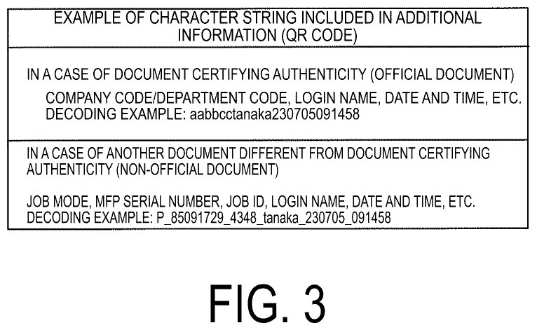

Here, with reference to FIG. 3, specific information given as additional information when the type of image information related to print is image information related to an official document, and job specific information given as additional information when the type of image information related to print is image information related to a non-official document will be described.

As exemplified in FIG. 3, when the type of the image information is an official document, examples of the specific information that is given as additional information to the image information to be printed include organization information regarding an organization to which a user who executes a print job belongs, such as a company code/department code. In addition, the specific information may include login information such as a login name of a user who has logged into the multifunction peripheral 10, and information regarding date and time information or the like such as a date and time of print. The organization information is not limited to a company code/department code, and is not particularly limited as long as the organization information is information that can specify a company (name) such as a company (firm) name, a company group name, a branch office (branch) name, a store name, a uniform resource locator (URL), a domain name or a contact address such as a telephone number, or specify a department of the organization to which a user who executes the print job belongs.

When the type of the image information is a non-official document, examples of the job specific information that is given as additional information to the image information to be printed include job information relating to a print job such as a job mode and a job ID, and apparatus information of the multifunction peripheral 10 such as a multifunction peripheral/printer (MPF) serial number. In addition, the job specific information may include login information such as a login name of a user that has logged into the multifunction peripheral 10, and information regarding date and time information such as the date and time of print. The job information is not limited to a job mode and a job ID. For example, in the case where the job is a print job, the job information is not particularly limited as long as the job information is information regarding a specific setting value related to the execution of the print job such as the number of print sheets or a color mode/monochrome mode.

Alternatively, in the case where the print job to be executed is a print job utilizing a setting history of a print job having been executed, the job information is not particularly limited as long as the job information is information regarding the job to be executed such as the setting history ID for specifying the above setting history. The apparatus information of the multifunction peripheral 10 is not limited to the MFP serial number, and is not particularly limited as long as it is information capable of specifying the multifunction peripheral 10 such as a device name of the multifunction peripheral 10 (for example, an account name or an account ID for a specific server), a network address, or an installation location of the multifunction peripheral 10.

FIG. 3 also illustrates an example of specific information or job specific information decoded by reading an image obtained by encoding the specific information or job specific information with a reading device such as a code reader.

A decoding example in the case of an official document (specific information) is a character string including “aabbcc” as a company code/department code, “tanaka” as a login name, and “230705091458” (2023/07/05 09:14:58) as a date and time. With respect to the decoding of a code related to specific information, in consideration of security against a third party, it is preferable that character strings representing the company code/department code, the login name, and the date and time be connected and represented without any delimiter (for example, an underscore) so as to make it difficult to recognize the decoded result at a glance.

On the other hand, a decoding example of a non-official document (job specific information) is a character string including “P” as a job mode (print job), “85091729” as an MFP serial number, “4348” as a job ID, “tanaka” as a login name, and “230705091458” (2023/07/05 09:14:58) as a date and time. With respect to the decoding of a code related to a job specific information, in consideration of convenience of a (login) user, it is preferable that character strings representing the job mode, the MFP serial number, the job ID, the login name, and the date and time be connected and represented using delimiters so as to make it easy to recognize the decoded result at a glance.

Referring back to FIG. 2, the output image information generation program 1943 is a program that is read out by the controller 11 when generating output image information to be printed on a medium by combining image information related to a print job and encoded information generated by reading out the code generation program 1942. The controller 11, after reading out the output image information generation program 1943, generates output image information in consideration of the print layout on the medium. For example, a code related to additional information can be given together with another image (for example, a watermark, a stamp, or a date print). However, when a print position related to the image of the code and a print position related to another image overlap each other, the code related to the additional information can be preferentially printed. In this case, the controller 11 can perform adjustment in such a manner that the print position of the code related to the additional information does not overlap with the print position of another image by restricting the print of the another image or changing the print position of the another image. The print position of the code related to the additional information is preferably set to the upper right of the image forming surface of the medium so as not to affect the print of the image information related to the print job. However, the print position of the code related to the additional information can be appropriately changed and set by the user. When a certain kind of image has already been printed at the print position of the code related to the additional information, the controller 11 may overwrite the above image with the image of the code related to the additional information. When encoded information related to specific information or job specific information as additional information has not been generated, that is, when a command for giving additional information to the image information related to the print job has not been issued, the controller 11, after reading out the output image information generation program 1943, generates output image information for printing with only the image information related to the print job. Then, the controller 11, after having generated the output image information, shifts to a job mode for executing the print job and executes the print job by reading out the job control program 192.

The authentication information storage area 195 is a storage area that stores authentication information of a user who attempts to log into the multifunction peripheral 10 (for example, a combination of a login user name and a login password related to user authentication). The controller 11, after reading out the authentication program 193, performs a user authentication process by comparing a login user name and login password input by the user with the authentication information read out from the authentication information storage area 195.

The history log storage area 196 stores a history log related to the executed job. The history log will be described later.

The apparatus information storage area 197 stores apparatus information such as a serial number, a device name, a network address, and an installation location of the multifunction peripheral 10. The apparatus information stored in the apparatus information storage area 197 is used as job specific information that is given to image information to be printed.

### 1.2.2 Terminal Device 30

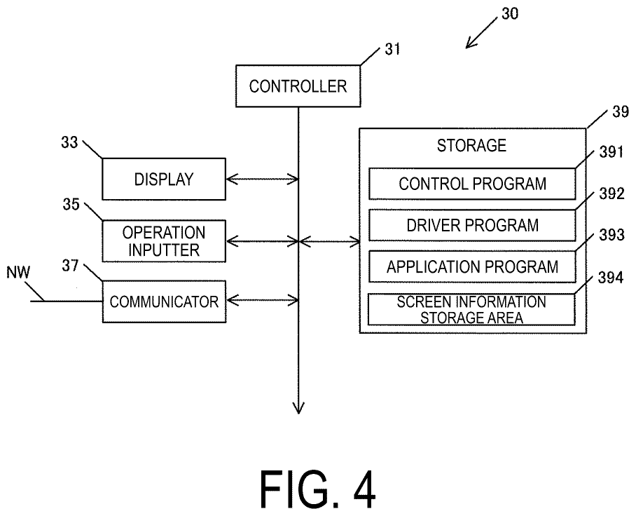

A functional configuration of the terminal device 30 will be described. FIG. 4 is a diagram for explaining the functional configuration of the terminal device 30. The terminal device 30 includes a controller 31, a display 33, an operation inputter 35, a communicator 37, and a storage 39.

The controller 31 controls the entire terminal device 30. The controller 31 is configured of, for example, one or multiple arithmetic devices (CPUs). The controller 31 implements its function by reading and executing various programs stored in the storage 39.

The display 33 is a display device that displays various types of information for a user or the like. The display 33 can be configured of, for example, an LCD or an organic EL display.

The operation inputter 35 is an input device that receives input of information by the user or the like. As the operation inputter 35, an input device such as a keyboard, a mouse, or a touch panel can be used.

The communicator 37 includes one or both of wired and wireless interfaces for performing communication with another device (e.g., the multifunction peripheral 10) via, for example, a LAN, a WAN, the Internet, or a telephone line. Note that the communicator 37 may include an interface related to a (short-range) wireless communication technology such as Bluetooth (trade name), Wi-Fi (trade name), ZigBee (trade name), IrDA, or wireless USB.

The storage 39 is constituted of one or more storage devices and stores various programs and various types of data necessary for the operation of the terminal device 30. The storage 39 can be configured of a storage device such as a RAM, an HDD, an SSD, or a ROM.

In the first embodiment, the storage 39 stores a control program 391, a driver program 392 and an application program 393, and secures a screen information storage area 394.

The control program 391 is a program that is read out by the controller 31 when performing centralized control of the terminal device 30. The controller 31, after reading out the control program 391, functions as an OS, and, for example, controls driving of hardware such as the display 33, the operation inputter 35 and the communicator 37, activates and terminates an application driven on the OS, and manages files.

The driver program 392 is a printer driver that operates on the OS. The driver program 392 is a program that is read out by the controller 31 when transferring/receiving a print job with the multifunction peripheral 10 via the application. When the controller 31, after reading out the driver program 392, receives a print command for an official document or a non-official document via the application, it displays a print job execution screen on the display 33 for printing the document. The controller 31 generates a print job based on the print setting received from the user via the print job execution screen and transmits the generated print job to the multifunction peripheral 10.

The application program 393 is a program that the controller 31 reads out upon receiving an activation command from the user. The controller 31, after reading out the application program 393, functions as the application, and provides specific functions in response to the purpose of the user, such as document generation of an official document, a non-official document or the like, graphic rendering, and Internet browsing. The application program 393 can be acquired by installation using a recording medium such as a CD or a DVD, downloading from a service providing server (not illustrated), or the like.

The screen information storage area 394 is a storage area that stores screen information (image/screen content) for configuring a setting screen for receiving a selection of the multifunction peripheral 10 to execute a print job, a print execution screen corresponding to the printer driver, and the like.

### 1.3 Procedure

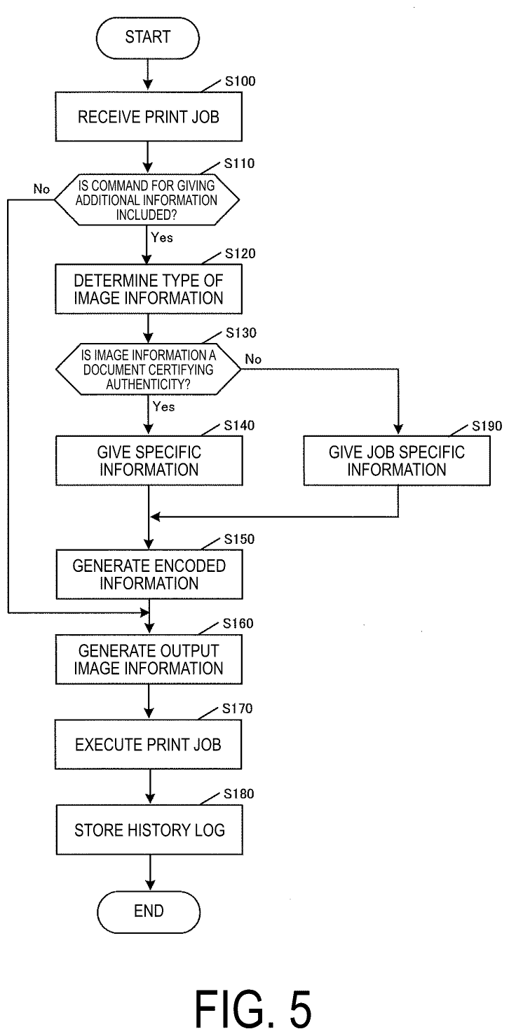

Next, a procedure according to the first embodiment will be described with reference to a flowchart illustrated in FIG. 5. FIG. 5 is a flowchart for explaining a process in which a print job is received, the print job is executed, and then a history log is generated. In particular, the controller 11 of the multifunction peripheral 10 reads out the job control program 192, the additional information-related program 194, and the like, thereby executing the process explained in FIG. 5.

The controller 11 receives a print job to be executed (step S100). When a print job is received, the controller 11 determines whether a command for giving additional information to image information related to the print job is included (step S110).

When it is determined that a command for giving additional information to image information related to the print job is included, the controller 11 determines the type of the image information (step S110; Yes, then proceed to step S120). On the other hand, when it is determined that a command for giving additional information to image information related to the print job is not included, the controller 11 generates output image information using only the image information related to the print job (step S110; No, then proceed to step S160). Then, the controller 11 executes printing based on the generated output image information (step S170). The controller 11 generates a history log related to the executed print job and stores the generated history log in the history log storage area 196 of the storage 19, thereby ending the process (step S180).

When it is determined in the processing of determining the type of image information that the image information is image information of an official document (a document that certifies authenticity), the controller 11 decides to give specific information as additional information (step S130; Yes, then proceed to step S140). On the other hand, when it is determined that the image information is image information of a non-official document (a document that does not certify authenticity), the controller 11 decides to give job specific information as additional information (step S130; No, then proceed to step S190).

Then, the controller 11 generates encoded information related to additional information of either the specific information decided to be given in step S140 or the job specific information decided to be given in step S190 (step S150).

Subsequently, the controller 11 combines the encoded information generated in step S150 with the image information related to the print job, thereby generating the output image information (step S160). Then, the controller 11 executes printing based on the generated output image information (step S170). The controller 11 generates the history log related to the executed print job and stores the generated history log in the history log storage area 196 of the storage 19, and ends the process (step S180).

### 1.3 Operation Examples

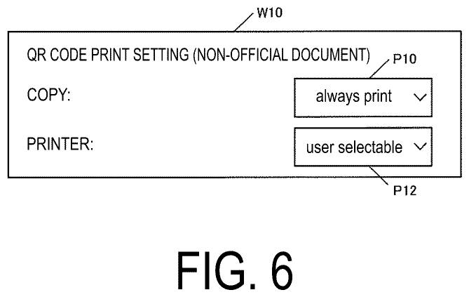

Next, operation examples according to the first embodiment will be described. FIG. 6 is a configuration example of a QR code print setting screen W10 for receiving a setting of whether to give a code (QR code) as additional information to an image related to image information of a print job to be executed. The QR code print setting screen W10 can be displayed via the system setting screen or the like of the multifunction peripheral 10.

The QR code print setting screen W10 exemplified in FIG. 6 relates to printing of image information (non-official document) related to a copy job or a print job, and includes a pull-down menu P10 and a pull-down menu P12 for receiving a selection of whether to give a QR code to an image related to the image information.

When a job to be executed is a copy job, the pull-down menu P10 is a pull-down menu for receiving a selection of whether to give a QR code to an image related to image information of the copy job. When a job to be executed is a print job, the pull-down menu P12 is a pull-down menu for receiving a selection of whether to give a QR code to an image related to image information of the print job. In the multifunction peripheral 10 according to the first embodiment, it is possible to select a mode of giving a QR code in accordance with the type of the job.

For example, the menu “always print” indicated in the pull-down menu P10 refers to a mode in which a QR code is always given regardless of the selection by the user. On the other hand, the menu “user selectable” indicated in the pull-down menu P12 refers to a mode in which the user can select whether to give a QR code via a job execution screen explained in the next drawing.

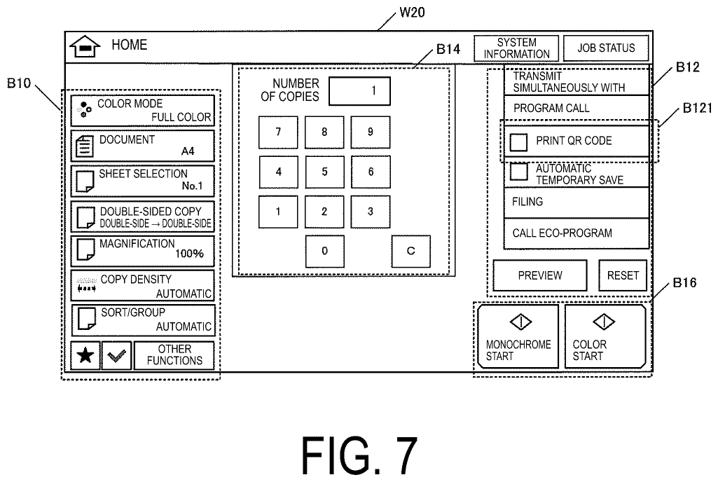

FIG. 7 is a configuration example of a copy execution screen W20 related to a copy job. The copy execution screen W20 can be displayed via, for example, a home screen (not illustrated).

In the case of a copy job, a target to which a QR code is given as additional information is image information related to a copy target image generated by an image sensor scanning a document set on a flatbed or an automatic document feeding device. In FIG. 7, an aspect in which a QR code is given to the image information via the copy execution screen W20 is described.

The copy execution screen W20 has a screen configuration in which all settings related to the execution of the copy job can be made. The copy execution screen W20 includes setting value buttons B10, operation control buttons B12, a button for specifying the number of copies B14, and start buttons B16.

The setting value buttons B10 are each a button for receiving selection and input of a setting value that can be set by the user from among the setting values related to the copy job. For example, the user can set a setting value related to a color mode by selecting a color mode button and selecting a desired setting value from items such as “full color”, “monochrome”, “single color”, and “automatic (color/monochrome)” (not illustrated) related to color mode selection. FIG. 7 is an example in which seven types of setting value items of “color mode”, “document”, “sheet selection”, “double-sided copy”, “magnification”, “copy density”, and “sort/group” are provided as settable setting value items.

The setting value buttons B10 include an “other functions” button in addition to the setting value items described above. By selecting the “other functions” button, the user can call other setting value items other than the setting value items being displayed, and select and input setting values.

The operation control buttons B12 include, in addition to a preview button and a reset button, extended function buttons such as a “transmit simultaneously with print” button, a “program call” button, and a “filing” button. For example, by selecting the “transmit simultaneously with print” button, the user can simultaneously perform printing of the read image and transmission to a predetermined destination (for example, E-mail transmission, facsimile transmission, or the like) along with the execution of the copy job.

The operation control buttons B12 include a “print QR code” button B121. The “print QR code” button B121 is a button for receiving a selection of whether to give a QR code to an image related to image information of the copy job. When the “print QR code” button B121 is selected by the user, the controller 11 prints, on a medium, an image in which the QR code is given to the copy target image. When the selection of the “print QR code” button B121 is received, the controller 11 may display an additional information setting screen (not illustrated) as a sub-screen for receiving input of additional information (e.g., specific information or job specific information) to be printed as a QR code or receiving selection of a type of the image information (official document or non-official document). The display of the “print QR code” button 121 may be restricted in the case where the menu “always print” is selected on the QR code print setting screen W10 described in FIG. 6 (the “print QR code” button 121 is set in a non-selectable state by display control such as non-display or gray-out display).

The button for specifying the number of copies B14 is a button for receiving input relating to setting the number of copies.

The start buttons B16 include a monochrome start button and a color start button. In a case where a monochrome copy is desired, the user selects the monochrome start button. On the other hand, in a case where a color copy is desired, the user selects the color start button. When the user selects either the monochrome start button or the color start button, the controller 11 executes a process related to a copy job.

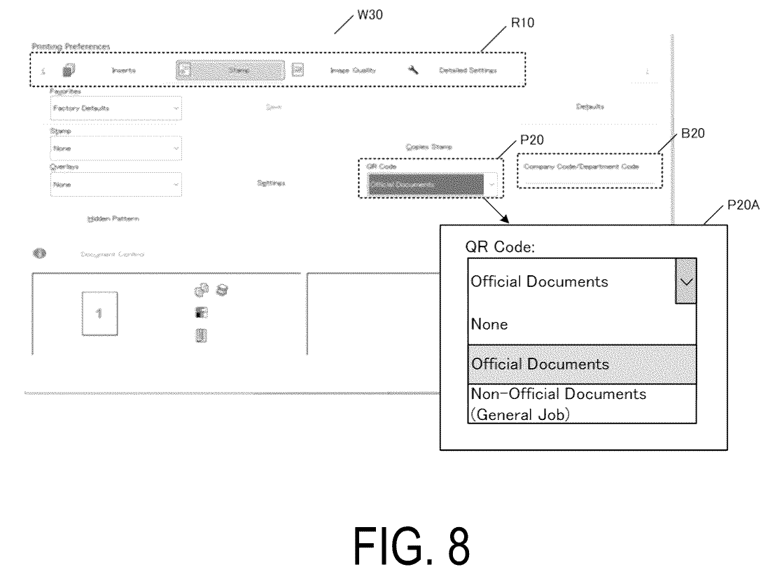

FIG. 8 is a configuration example of a print execution screen W30 related to a print job. The print execution screen W30 is displayed when a print command is received via a predetermined application in the terminal device 30. In the case of a print job, a target to which a QR code is given as additional information is image information related to a print target image generated via a predetermined application. In FIG. 8, an aspect in which a QR code is given to the image information via the print execution screen W30 is described.

The print execution screen W30 includes a print setting area R10. The print execution screen W30 in FIG. 8 is an example in which print settings selectable by the user that include insertion print (“Inserts”), “Stamp”, “Image Quality”, and “Detailed Settings” are provided in the print setting area R10. In the print setting area R10, the user can perform print setting in accordance with the displayed setting content with regard to any of the settings of insertion print, stamp, image quality, and detailed settings.

FIG. 8 illustrates an example in which the setting related to giving a QR code is provided in the print setting related to the stamp. In FIG. 8, the setting related to giving a QR code is provided in the print setting related to the stamp, but the setting related to giving a QR code can be provided in another print setting such as the detailed settings.

In this case, a QR code-giving target selection pull-down menu P20 is a pull-down menu for receiving a selection of a document type to which a QR code is given as additional information. FIG. 8 illustrates an example in which official documents are selected as documents to which QR codes are to be given. The QR code-giving target selection pull-down menu P20 can develop a display area downward in the drawing by a click operation on a downward arrow, or the like. In a development screen P20A, “None” (no selection), “Official Documents”, and “Non-Official Documents (General Job)” are displayed as items that can be selected by the user. By selecting a desired item, the user can set the target to be given with a QR code to any of “None”, “Official Documents”, and “Non-Official Documents (General Job)”. When an official document is selected as the document to be given with a QR code by the user, the controller 11 of the multifunction peripheral 10 gives a QR code to the official document to be printed regardless of the QR code print setting received via the QR code print setting screen W10 exemplified in FIG. 6.

A specific information input box B20 is a box for receiving input of organization information as an example of specific information. The specific information input box B20 is an input box displayed when an official document is selected as the document type to be given with a QR code in the QR code-giving target selection pull-down menu P20. FIG. 8 is an example of an input box for receiving input of “Company Code/Department Code” as organization information. The user can include the input organization information in the additional information by inputting a company code/department code such as “aabbcc” (see FIG. 3).

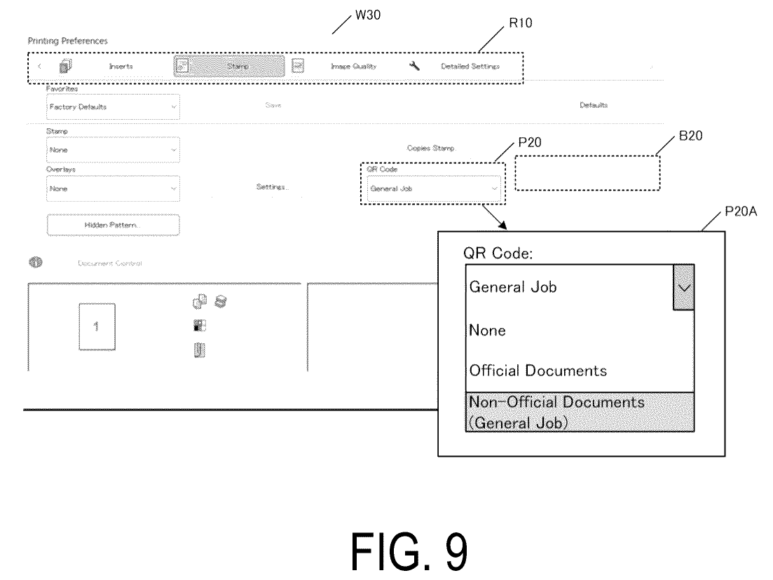

FIG. 9 is a configuration example of the print execution screen W30 when a non-official document (general job) is selected as the document type to be given with a QR code via the QR code-giving target selection pull-down menu P20 by the user. When the user selects a non-official document as the document type to which a QR code is to be given, the specific information input box B20 exemplified in FIG. 8 is not displayed on the print execution screen W30.

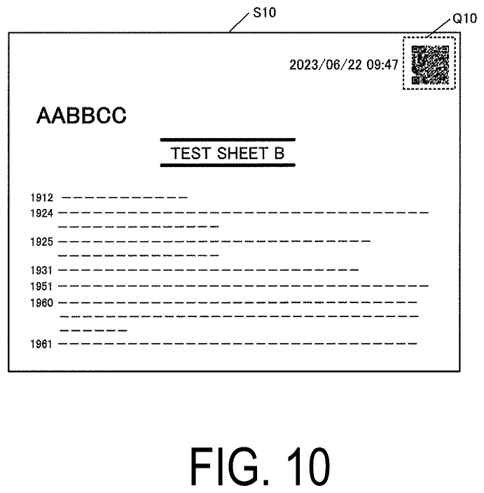

FIG. 10 is a diagram for explaining an example of a print result of an official document to which a QR code is given as additional information. In FIG. 10, in addition to official document text as image information related to the copy or print job, a QR code Q10 is printed on the upper right corner of a medium S10. The print position of the QR code Q10 is preferably the upper right corner of the medium so as not to affect the readability of the official document text, but the print position is not limited thereto. In addition to four corners of the upper right, upper left, lower right, and lower left of the medium, the QR code Q10 can be printed on a rear side of the print face for the official document text in a case where the device configuration is capable of double-sided printing. The print position of the QR code Q10 can be optionally set or changed by the user. Although a print size of the QR code Q10 can be optionally set, it is preferable that the print size be fixed regardless of the medium size in consideration of reading performance of a reading device such as a code reader.

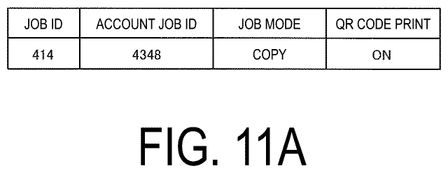

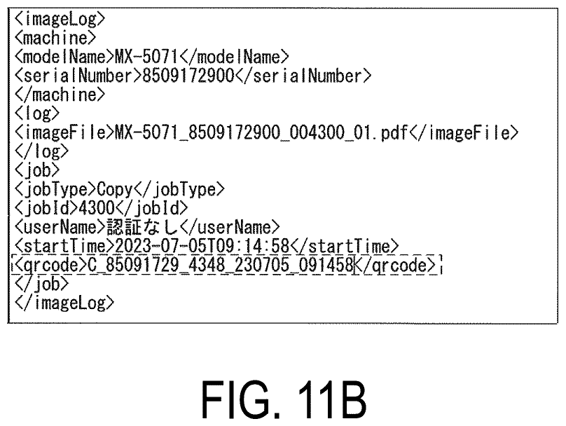

FIG. 11A is a diagram for explaining an example of a history log generated by the controller 11 of the multifunction peripheral 10 in step S180 of FIG. 5, after the execution of the print job. FIG. 11B is a diagram for explaining an example of a log file generated as a history log.

As illustrated in FIG. 11A, the history log includes a job ID, an account job ID, a job mode, and a QR code print. The job ID is an identifier assigned to uniquely identify an executed job. For example, in a case where the multifunction peripheral 10 and the terminal device 30 cooperate with each other by a specific cooperative application, the account job ID is a job ID used by the cooperative application. The job mode is a mode of the executed job (print or copy). The QR code print indicates whether a QR code is printed with respect to the image printed by the executed job. The information about whether a QR code has been printed with respect to the image printed by the executed job is also recorded in the <qrcode></qrcode>tag (a chain-line frame in the drawing) of the log file exemplified in FIG. 11B. When the image related to the executed job is printed again using the history log exemplified in FIG. 11A or FIG. 11B, the controller 11 can decide whether to give the QR code based on the setting related to the history log.

As described above, in the first embodiment, in response to any of the case where the type of image information to be printed is an official document and the case where the type thereof is a non-official document, it is possible to control the giving of additional information to be printed as a code together with the document or the content of the additional information. Thus, according to the first embodiment, it is possible to perform flexible output management of image information related to an official document or a non-official document as a printed matter.

### 2. Second Embodiment

An aspect of a second embodiment is as follows: in the first embodiment, only in a case where image information related to a job to be executed is determined to be image information of an official document and the job is not a copy job but a print job, it is decided that specific information is given as additional information. In the second embodiment, a print job and a copy job are described while being distinguished from each other.

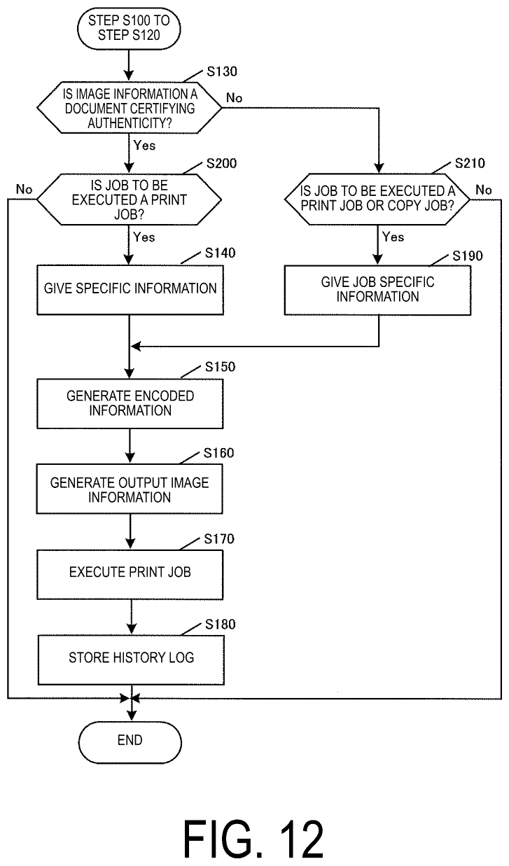

A procedure according to the second embodiment can be a process achieved by replacing the flowchart of FIG. 5 according to the first embodiment with a flowchart of FIG. 12. Note that the same processing as the processing described in FIG. 5 is denoted by the same step number, and description thereof is omitted.

In the processing of determining the type of image information, when the image information is determined to be image information of an official document, the controller 11 determines whether the job to be executed is a print job (step S130; Yes, then proceed to step S200).

In a case where it is determined that the job to be executed is a print job, the controller 11 decides to give specific information as additional information (step S200; Yes, then proceed to step S140). On the other hand, when it is determined that the job to be executed is not a print job, the controller 11 ends the process (step S200; No, then proceed to end).

In the processing of determining the type of image information, when the image information is determined to be image information of a non-official document, the controller 11 determines whether the job to be executed is a print job or a copy job (step S130; No, then proceed to step S210).

In a case where it is determined that the job to be executed is a print job or a copy job, the controller 11 decides to give job specific information as additional information (step S210; Yes, then proceed to step S190). On the other hand, when it is determined that the job to be executed is neither a print job nor a copy job, the controller 11 ends the process (step S210; No, then proceed to end). In the determination of the job type in step 210, a scan job may be included as a job type to be executed.

As described above, in the second embodiment, only when the image information of the job to be executed is an official document and the job type is a print job, specific information is given as additional information. Therefore, according to the second embodiment, in addition to the effects obtained in the first embodiment, for example, it is possible to prevent a guest user from illegally copying and duplicating official documents by directly operating the multifunction peripheral 10.

### 3. Third Embodiment

An aspect of a third embodiment is as follows: when a user authentication function is enabled and the login of a user is successful, login information of the login user is included in specific information or job specific information.

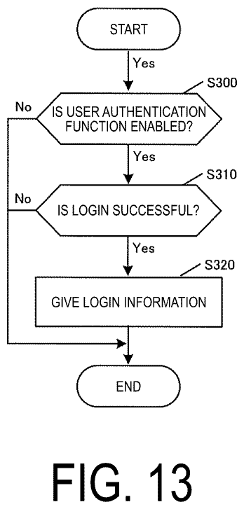

FIG. 13 is a flowchart for explaining a process in which login information of a login user is included in specific information or job specific information in the third embodiment. The process explained in FIG. 13 can be included in internal processing of step S150 in FIG. 5.

The controller 11 determines whether the user authentication function is enabled (step S300). When it is determined that the user authentication function is enabled, the controller 11 determines whether the login of the user into the multifunction peripheral 10 is successful (step S300; Yes, then proceed to step S310). In a case where it is determined that the login of the user is successful, the controller 11 gives login information of the login user to the specific information or the job specific information and ends the process (step S310; Yes, then proceed to step S320).

On the other hand, in a case where it is determined that the user authentication function is disabled (Step S300; No) or in a case where the login of the user is unsuccessful (Step S310; No), the controller 11 ends the process. In this case, when the document to be printed is an official document, the controller 11 preferably restricts printing of the official document in order to ensure authenticity of the official document.

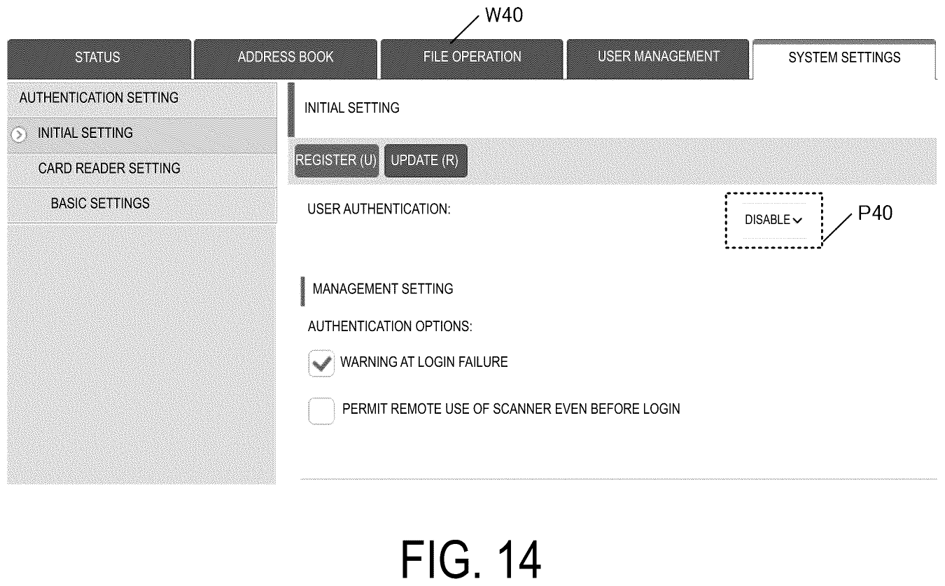

FIG. 14 is an example of a system setting screen W40 provided with a user authentication pull-down menu P40 for receiving a setting of enabling/disabling the user authentication function by the user. A (administrator) user can switch the setting between enabling and disabling the user authentication function via the user authentication pull-down menu P40 on the system setting screen W40.

As described above, according to the third embodiment, it is possible to control whether to include the login information of the login user in the specific information or the job specific information, depending on whether the user authentication function is enabled or disabled and whether the user authentication is successful or unsuccessful.

### 4. Fourth Embodiment

An aspect of a fourth embodiment is as follows: in accordance with a giving mode of additional information (QR code) set by a user on the QR code print setting screen W10 as a setter exemplified in FIG. 6 of the first embodiment, giving of additional information to image information is controlled.

In the fourth embodiment, when the giving mode of additional information set by the user is “user selectable” as a first giving mode, the controller 11 forcibly gives additional information to image information related to an official document. On the other hand, the controller 11 controls whether to give additional information to image information related to a non-official document by the selection of the user via the job execution screen.

When the giving mode of additional information set by the user is “always print” as a second giving mode, the controller 11 also gives additional information to image information for which a command of giving additional information is not issued, in addition to an official document and a non-official document. At this time, the controller 11 does not receive a selection by the user as to whether to give additional information to image information, and restricts the display of the setting items regarding the giving of additional information on the job execution screen exemplified in FIG. 7 to FIG. 9, for example.

As described above, according to the fourth embodiment, the giving of additional information to image information is controlled in accordance with the giving mode of additional information (QR code) set by the user. Therefore, in addition to the effects obtained in the first embodiment, the user only needs to decide the giving mode of the additional information, thereby making it possible to reduce the time and effort related to output management of image information as a printed matter.

The disclosure is not limited to the embodiments described above and can be changed in various manners. In other words, embodiments obtained by combining technical mechanisms appropriately changed without departing from the gist of the disclosure are also included in the technical scope of the disclosure.

Although some parts of the above-described embodiments are described separately for convenience of explanation, it is a matter of course that combinations can be executed within a technically allowable range.

The programs running on each device in the embodiments are programs for controlling a CPU or the like (programs for causing a computer to function) to implement the aforementioned functions in the embodiments. The information handled by these devices is temporarily accumulated in a transitory storage device (for example, a RAM) at the time of processing, is then stored in a storage device such as various read only memories (ROMs) or HDDs, and is read, corrected, and written by the CPU as needed.

As a non-transitory computer readable recording medium storing therein a program in the information processing device, any of a semiconductor medium (for example, a ROM or a nonvolatile memory card), an optical recording medium or a magneto-optical recording medium (for example, a digital versatile disc (DVD), a magneto optical disc (MO), a mini disc (MD), a compact disc (CD), or a Blu-ray (trade name) disc (BD)), a magnetic recording medium (for example, a magnetic tape or a flexible disk), and the like may be used. In this case, since the program recorded in the recording medium is read by a computer of the information processing device and executed by the computer, not only the aforementioned functions of the embodiments are implemented, but also the functions of the disclosure are implemented by performing processes in cooperation with an operating system, another application program, or the like based on the commands of the program.

In a case where the programs are distributed to the market, the programs can be stored and distributed in a portable recording medium, or can be transferred to a server computer connected via a network such as the Internet. In this case, it is a matter of course that the storage device of the server computer is also included in the disclosure.

In addition, each functional block or each characteristic of the device used in the above-described embodiments can be implemented and executed by an electric circuit, for example, an integrated circuit or a plurality of the integrated circuits. An electric circuit designed to implement the function described herein may include a general-purpose processor, a digital signal processor (DSP), an application specific integrated circuit (ASIC), a field programmable gate array (FPGA) or other programmable logic devices, discrete gate or transistor logic, discrete hardware components, or a combination thereof. The general-purpose processor may be a microprocessor, or any known processor, controller, microcontroller, or state machine. The above-described electric circuit may be constituted by a digital circuit or an analog circuit. In addition, in a case where an integrated circuit technology that replaces the current integrated circuit becomes available due to advancement of the semiconductor technology, one or more aspects of the disclosure can use a new integrated circuit based on the new integrated circuit technology.

### REFERENCE SIGNS LIST

10 Multifunction peripheral
11 Controller
13 Display
15 Operation inputter
17 Communicator
19 Storage
191 Control program
192 Job control program
193 Authentication program
194 Additional information-related program
1941 Image information determination program
1942 Code generation program
1943 Output image information generation program
195 Authentication information storage area
196 History log storage area
197 Apparatus information storage area
30 Terminal device
31 Controller
33 Display
35 Operation inputter
37 Communicator
39 Storage
391 Control program
392 Driver program
393 Application program
394 Screen information storage area

1. An image forming apparatus, comprising:
one or more controllers that control giving of additional information to image information; and
an image former that forms an image of a code related to the additional information to be given to an image of the image information in a case where the additional information is given under control of the one or more controllers,
wherein the one or more controllers give, to the image information, the additional information that differs in response to a type of the image information.

2. The image forming apparatus according to claim 1, wherein
in a case where the type of the image information is image information of a document that certifies authenticity of contents, the one or more controllers give specific information including organization information regarding an organization to which a user who executes a job relating to image formation of the document belongs as the additional information to the image information, and
in a case where the type of the image information is image information of another document different from the document that certifies authenticity of contents, the one or more controllers give job specific information including job information relating to image formation and apparatus information of the image forming apparatus as the additional information to the image information.

3. The image forming apparatus according to claim 2, wherein
the specific information or the job specific information includes login information of the user with respect to the image forming apparatus, and date and time information of image formation.

4. The image forming apparatus according to claim 2, wherein
in a case where the job relating to image formation of the document that certifies authenticity of contents is a print job, the one or more controllers decide that image information related to the document is a target to be given with the additional information, and give the additional information to the image information.

5. The image forming apparatus according to claim 2, wherein
in a case where the job relating to image formation of another document different from the document that certifies authenticity of contents is a print job or a copy job, the one or more controllers decide that image information related to the another document is a target to be given with the additional information, and gives the additional information to the image information.

6. The image forming apparatus according to claim 1, further comprising:
one or more storages that store a history of a job having formed an image by giving the additional information.

7. The image forming apparatus according to claim 3, wherein
the one or more controllers include user login information with respect to the image forming apparatus in the specific information or the job specific information in a case where a user authentication function is enabled.

8. The image forming apparatus according to claim 2, wherein
the one or more controllers restrict image formation of the document that certifies authenticity of contents in a case where a user authentication function is disabled.

9. The image forming apparatus according to claim 1, wherein
in a case where an image forming position of the code overlaps with an image forming position of another image different from the code, the one or more controllers perform image formation while prioritizing the code.

10. The image forming apparatus according to claim 9, wherein
the another image is an image related to a watermark, a stamp, or a date print.

11. The image forming apparatus according to claim 1, wherein
a size of the code is constant regardless of a size of a medium on which an image is to be formed.

12. The image forming apparatus according to claim 2, wherein
a character string represented by decoding the code included in the image of the document that certifies authenticity of contents is connected without a delimiter, and
a character string represented by decoding the code included in the image of the another document different from the document that certifies authenticity of contents is connected with a delimiter.

13. The image forming apparatus according to claim 1, further comprising:
a setter that receives, from a user, a setting of a giving mode relating to giving the additional information,
wherein the one or more controllers control giving of the additional information based on the giving mode received via the setter.

14. The image forming apparatus according to claim 13, wherein
in a case where a first giving mode is selected by the user, the one or more controllers forcibly give the additional information to the image information of the document that certifies authenticity of contents, and decides whether to give the additional information to image information of another document different from the document that certifies authenticity of contents based on the selection by the user.

15. The image forming apparatus according to claim 13, wherein
in a case where a second giving mode is selected by the user, the one or more controllers give the additional information to the image information of the document that certifies authenticity of contents, and to image information of another document different from the document that certifies authenticity of contents.

16. The image forming apparatus according to claim 2, wherein
in a case where the one or more controllers form again the image information of the document that certifies authenticity of contents and the image information of the another document different from the document that certifies authenticity of contents, the one or more controllers decide whether to give the additional information based on a setting at a time of previous image formation.

17. An image forming method, comprising:
controlling of giving additional information to image information; and
forming an image of a code related to the additional information to be given to an image of the image information in a case where the additional information is given,
wherein the additional information that differs in response to a type of the image information is given to the image information.
